(19) United States
(12) Patent Application Publication
(10) Pub. No.: US 2026/0360961 A1
(43) Pub. Date: Nov. 12, 2026

(54) Wireless data collection system

(71) Applicants: SAFRAN HELICOPTER ENGINES, BORDES (FR); SAFRAN ELECTRONICS & DEFENSE, PARIS (FR)

(72) Inventors: Fabien LAMAZERE, MOISSY-CRAMAYEL (FR); Mathieu ERACARRET, MOISSY-CRAMAYEL (FR); Nicolas FANTON, MOISSY-CRAMAYEL (FR)

(21) Appl. No.: 19/130,019

(22) PCT Filed: Nov. 8, 2023
(86) PCT No.: PCT/EP2023/081101

§ 371 Date: May 14, 2025

(30) Foreign Application Priority Data
Nov. 15, 2022 (FR) FR2211887

(51) Int. Cl. H01Q 1/00; B64C 27/00; B64D 27/40; H01Q 1/28

(52) U.S. Cl. CPC H01Q 1/002; B64C 27/00; B64D 27/40; H01Q 1/28

(57) ABSTRACT

A system for collecting data by electromagnetic signals includes, on the one hand, a collector provided with a first antenna having a first bandwidth, and, on the other hand, at least one remote electronic device including a second antenna tuned to exchange signals with the first antenna, characterized in that the device includes a thermal protection block in which the second antenna is embedded, and in that the second antenna is tuned in such a way that the second antenna and the thermal protection block form a radiating assembly having a second bandwidth coinciding with the first bandwidth. A vehicle includes at least one propulsion engine dis-posed in an engine compartment, and at least one remote device of such a system.

The present invention relates to the field of data collection in particular in vehicles, and for example for the collection of data in a hot environment such as the engine compartment of a vehicle.

### BACKGROUND OF THE INVENTION

Motor vehicles include an engine housed in an engine compartment more or less insulated, in particular thermally and acoustically, from the rest of the vehicle which houses a station for controlling the engine. To control the operation of the engine and/or ensure its maintenance, it is necessary to retrieve a certain number of pieces of information relating to the engine for example such as data on temperature, shocks, vibrations as well as configuration information (for example the product number P/N and the serial number S/N).

With regard to the retrieval of data relating to the operation of the engine: a conventional solution is to dispose sensors in the engine compartment and to connect them by electrical cables to the control station which collects the data in question. However, the use of cables increases the weight of the vehicle and therefore its energy consumption, and turns out to be rather constraining in terms of the design of the vehicles.

For the collection of the configuration information, a conventional solution is to keep up to date, in an information system outside of the vehicle, a list of the replaceable components used (mention is commonly made of LRU, from Line-Replaceable Unit). However, copying the data (P/N and S/N) is a source of work and especially of errors (failure to respect the estimated service life of an LRU or implementation of a non-compliant configuration).

Furthermore, in other fields of everyday life, for example such as packaging and parcel tracking, it is known to collect data via the technology RFID (from Radio Frequency Identification or radio-identification). This technology is implemented via systems comprising a reader and radio tags (commonly called RFID tags). The reader comprises a first electronic circuit with an integrated circuit connected to a first antenna having a first bandwidth and each radio tag comprises a second electronic circuit with an integrated circuit connected to a second antenna having a second bandwidth substantially identical to the first bandwidth. The first electronic circuit of the reader can thus communicate with the second electronic circuit via the exchange of electromagnetic signals. The radio tags are relatively fragile and very sensitive to heat.

### OBJECT OF THE INVENTION

The aim of the invention is in particular to allow a collection of data, such as identifiers, in a relatively hot environment by limiting the weight of the equipment necessary for the collection.

### SUMMARY OF THE INVENTION

For this purpose, according to the invention, a system for collecting data by electromagnetic signals is provided, comprising, on the one hand, a collector provided with a first antenna having a first bandwidth, and, on the other hand, at least one remote electronic device including a second antenna tuned to exchange signals with the first antenna. The device includes a thermal protection block in which the second antenna is embedded, and the second antenna is tuned in such a way that the second antenna and the thermal protection block form a radiating assembly having a second bandwidth coinciding with the first bandwidth.

Thus, it is possible to collect the data without resorting to electrical cables while ensuring reliable transmission of the data. However, to protect the antenna from heat, the antenna is embedded in a thermal protection block. However, the block alters the properties of the antenna so that, if the antenna is tuned to the first bandwidth, poor signal transmission is obtained. To overcome this, the antenna is tuned to form with the protection block a radiating assembly having a second bandwidth that coincides with the first bandwidth thus allowing an exchange of signals of the same quality as in the absence of a thermal protection block. With the invention, the tuning of the second antenna thus takes into account the influence of the thermal protection block on the electromagnetic radiation. The invention is adapted to use in the environment of a heat engine with temperatures between 100 °C and 250 °C or even higher.

Other features and advantages of the invention will appear upon reading the following description of specific and non-limiting embodiments of the invention.

### BRIEF DESCRIPTION OF THE DRAWINGS

Reference will be made to the appended drawings, among which:

FIG. 1 is a partial schematic perspective view of an aircraft equipped with a system according to the invention, showing more particularly an engine compartment of this aircraft;

FIG. 2 is a schematic block view of a data collection system according to the invention;

FIG. 3 is a schematic view of this remote device, in a cross-section according to a plane perpendicular to the substrate of the electronic circuit of the remote device.

### DETAILED DESCRIPTION OF THE INVENTION

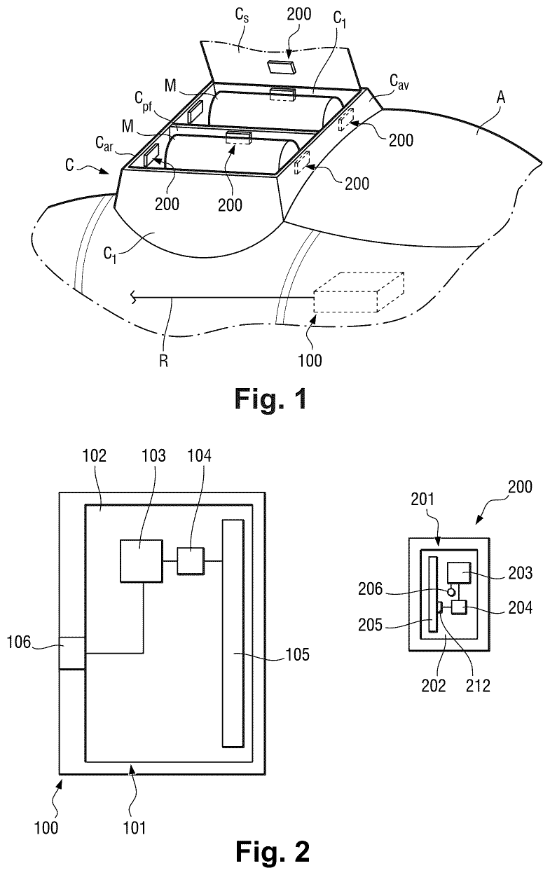

In reference to FIG. 1, the invention is described here applied to an aircraft A including two engines M placed in the same engine compartment C. The engine compartment C comprises a front partition Cav, a rear partition Car, two lateral partitions Cl and a firewall Cpf separating the two engines M from one another. The engine compartment C includes an upper opening closed by an upper cover Cs.

In reference to FIG. 2, the system according to the invention comprises a data collector (or reader) generally designated as 100 and here a plurality of remote electronic devices 200.

The collector 100 comprises an electronic circuit 101 which includes a printed circuit board 102 carrying an integrated circuit 103 and a transmitter/receiver 104 connected by a linking cable to an antenna 105 (or first antenna) which is separate from the electronic circuit 101. The integrated circuit 103 comprises a processor and a memory containing a program that can be executed by the processor and data. The printed circuit board 102 further comprises at least one connector 106 allowing to connect the electronic circuit 101 to an avionics network R of the aircraft A. The antenna 105 is tuned to a frequency band (or first bandwidth) that is part of the frequency bands used for the RFID devices. The collector 100 here is on board the aircraft: the electronic circuit 101 is disposed outside of the engine compartment C; the antenna 105 is disposed in the engine compartment.

Each remote device 200 comprises an electronic circuit 201 which includes a printed circuit board 202 carrying an integrated circuit 203 and a transmitter/receiver 204 connected to an antenna 205 tuned to a second frequency band (or second bandwidth) to be able to communicate with the collector 100 as will be seen. The integrated circuit 203 comprises a processor and a memory containing a computer program, which can be executed by the processor, and data.

The remote device 200 can be arranged to carry out at least one of the following functions:
a function for memorizing an identification of the component onto which it is fastened;
a function for memorizing a parameterization or a configuration of the component onto which it is fastened;
function for measuring and memorizing an environ-mental parameter of the component onto which it is fastened, etc.

For this purpose, the electronic circuit 201 of the remote device 200 is connected to a sensor 206 (for example of temperature, shock or vibration or pressure).

The remote device 200 is an RFID device of the passive type in the sense that it does not include a battery and is powered by the energy of the signals it receives via the antenna 205. This type of power supply of the RFID devices is conventional.

The remote device 200 includes a thermal protection envelope in which at least the antenna 205 is housed, but here also the entire electronic circuit 201. The remote device 200 also includes a means for compensating for an influence of the thermal protection envelope on the electromagnetic signals exchanged between the two antennas 105, 205. The compensation means is arranged for the electromagnetic signals transmitted in the first bandwidth by the antenna 105 to be received in the second bandwidth by the antenna 205 and vice versa.

Thus, the collector 100 can retrieve the memorized data by interrogating the remote device 200. The collection is initiated by the collector 100 which sends a request signal containing a request for data (for example, for identification), the electronic circuit 201 of the remote device 200, powered by the energy of the request signal, transmits an identification signal containing the identifier of the component onto which it is fastened before sending:
a data signal containing the other data contained in its memory.
an identification signal containing a TID (Transponder ID).

The electronic circuit 101 of the collector 100 is programmed to collect the data automatically before each flight, during the flight or after the flight. The electronic circuit 101 of the collector 100 can be programmed to collect data periodically or in one go. The data retrieved by the collector 100 is then transmitted to a predictive maintenance system for example either via the avionics network R, or by an RFID link initiated with a reader of a maintenance operator. The data retrieved by the collector 100 can be stored in the memory of the collector 100 or in a memory connected to the avionics network R.

It should be noted that the collector 100 can also be programmed to update data memorized in the electronic circuit 201 of the remote device 200, such as:
the identifier of the component with which the remote device 200 is associated,
a configuration or a parameterization of the component with which the remote device 200 is associated,
the value of an alert threshold,
the value of a threshold for controlling the memorization or the transmission of the parameter measured by the remote device 200, etc. For example, in the latter case applied to a remote device 200 measuring the temperature, the temperature is not memorized or is not transmitted as long as it is lower than the threshold value. Furthermore, the temperature can be used to extend the service life of the remote device 200. Indeed, if a remote device 200 is interrogated at a temperature that is too high, there is a risk of it ageing prematurely. It is therefore preferable that a remote device 200 does not respond to an RFID request if its internal temperature is too high.

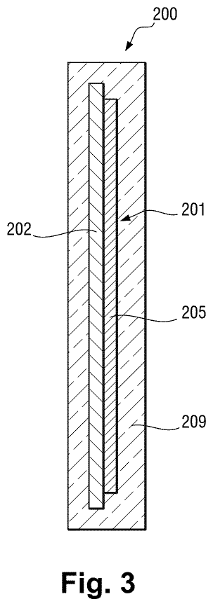

According to the invention, and as shown in FIG. 3, the device includes a thermal protection block 209 in which the second antenna 205 is embedded (namely the electrically conductive part of the second antenna 205 and its support). The second antenna 205 is tuned in such a way that the second antenna 205 and the thermal protection block 209 form a radiating assembly having a second bandwidth coinciding with the first bandwidth. “Coinciding” means that each of these two bandwidths overlaps with the other over at least one third, or even over half of this bandwidth, or more according to the transmission reliability sought. The bandwidth here extends between −3 dB and +3 dB around the frequency corresponding to the maximum strength of the transmitted signals.

The thermal protection block 209 is formed by molding by disposing the electronic circuit 201 in a mold including rods supporting the electronic circuit 201 at a distance from the walls of the mold, and by pouring the polymer resin into the mold so that it encapsulates the entirety of the electronic circuit 201 while also covering the antenna 205 (the antenna 205 being in contact with the resin of the thermal protection block 209). The electronic circuit 201 of the remote electronic device 200 comprises at least one electronic component 212 for tuning the second antenna 205, the tuning electronic component 212 having been chosen to compensate for a shift in resonance frequency of the second antenna 205 caused by the thermal protection block 209. This shift is determined empirically from tests carried out for various thicknesses of thermal protection block 209 around the antenna 205, the resonance frequency of which in air is fixed and known, said thickness being determined according to a thermal conductivity of the thermal protection block 209 and an estimated surrounding temperature during operation.

For example, it is known that on a given remote device applied to an RFID transmission, a thickness of 5 mm of resin surrounding the antenna 205 causes a frequency shift equal to 131 MHz: the waves emitted by the antenna 205 out of the thermal protection block 209 have a frequency of 737 MHz instead of the expected 868 MHz. Therefore, when the antenna 205 of a remote electronic device 200 must be encapsulated in a thermal protection block 209 of this resin 5 mm thick, it is known that the antenna must be tuned to a frequency of 1019 MHz, or the sum of the expected 868 MHz and the empirically determined shift of 131 MHz.

The tuning electronic component 212 here is part together with the antenna 205 of a resonant circuit. This can be a passive resonant circuit, in which the value of a resistance or of a capacitance, forming the tuning electronic component, allows to adjust the resonance frequency of the circuit in question to the determined frequency value. A more elaborate tunable resonant circuit can also be used. The frequency shift could also be determined by simulation on the basis in particular of the electrical permittivity of the resin and the thickness of resin covering the antenna.

Alternatively, the antenna 205 comprises at least one portion (shape and dimensions of the tracks) designed so that the assembly formed by the antenna 205 and the thermal protection block 209 resonates in the first bandwidth.

In the preferred embodiment of the invention, the system comprises several remote devices 200 distributed in the engine compartment C, namely:
at least one on the front partition Cav,
at least one on the rear partition Car,
at least one on the upper cover Cs,
at least one on the firewall Cpf.

To improve the transmission of the signals, wave return metasurfaces fastened onto the partitions Cav, Car, Cs and/or Cpf and/or the cover Cs can be provided to return the waves coming from the antennas 205 to the collector 100 and vice versa. Metasurfaces are surfaces that reflect the waves at a given frequency, here that of the RFID signals. They can optionally be designed to reflect these waves in a directed manner. It is possible to encapsulate/embed at least one of the metasurfaces in a thermal protection material like the antenna 205.

Of course, the invention is not limited to the embodiment described but encompasses any alternative falling within the scope of the invention as defined by the claims.

In particular, the remote device can have a structure different from that described.

The thermal protection block/envelope can be disposed around the antenna only, the antenna being connected by a cable or a connector to the rest of the electronic circuit.

Other polymer resins can be chosen to form the thermal protection envelope and for example an epoxy resin or a silicone resin or a PG 231 or PG 355 resin. The range of use in terms of temperature is preferably from −40 °C (or even −60 °C) to +150 °C, or even more and beyond 250 °C, and the thermal conductivity less than 1W/ (m·K). Moreover, a resin as hard as possible, with a Shore D hardness at least equal to 30, is preferably chosen to ensure mechanical protection of the antenna and of the electronic circuit.

Optionally, the thermal protection block 209 has, around the second antenna 205, a thickness determined according to a thermal conductivity of the thermal protection block 209 and an estimated surrounding temperature during operation, and the tuning of the second antenna 205 depends on said thickness.

The material of the thermal protection block/envelope is preferably chosen according to its performance in terms of radio wave transmission.

The invention can also be applied to the RFID devices of the active type, that is to say comprising a battery for powering the electronic circuit for uses at temperatures preferably below 200 °C.

The remote device 200 can be arranged to carry out functions other than those indicated and for example one or more functions allowing to estimate a service life of the component with which it is associated, like:
incrementing a counter at each reading of the remote device 200 by the collector 100 on the basis of the hypothesis that a reading is carried out after each operating cycle;
incrementing a counter on a specific RFID command used at each start of the engine to count the number of cycles during which the engine is running;
measuring a temperature via an integrated temperature sensor to count the number of cycles or even the operating time of the LRU (which supposes that the remote device 200 is permanently powered to measure and process temperature information: either because the antenna 205 is permanently subjected to radioelectric radiation, or because the remote device 200 incorporates a battery);
measuring an acceleration via an integrated accelerometer to count the number of cycles or even the operating time of the LRU (which supposes that the remote device 200 is permanently powered to measure and process acceleration information: either because the antenna 205 is permanently subjected to radioelectric radiation, or because the remote device 200 incorporates a battery).

The remote device can have a much more basic structure than that described and comprise only passive components.

The antenna can have a structure different from that described and be made from any electrically conductive element such as a track of a printed circuit, a cable, a bar or a metasurface.

There are two ways to identify the component with which a remote device 200 is associated:
either the data S/N and P/N are stored in the memory of the remote device 200 as described above;
or the collector 100 retrieves the identifier of the remote device 200 (this identifier is often called TID and is specific to each RFID device) and it is the information system that makes the match between the TID and the P/N and S/N.

The first solution is simpler for retrieving the P/N and S/N. The second solution is less expensive in energy, the TID being more directly accessible (this is important when the remote device 200 is at the range limit of the RFID antennas and therefore has little energy).

The collector can be on board the aircraft or be independent of the aircraft to be used on the ground by a maintenance operator.

The invention is applicable to any vehicle equipped with a propulsion engine, i.e. vehicles of any type, such as land, nautical or air vehicles, whether or not crewed. With regard to airborne vehicles, the invention is applicable to fixed-or rotating-wing aircraft, regardless of the number of engines that they comprise.

1. A system for collecting data by electromagnetic signals, comprising a collector provided with a first antenna having a first bandwidth, and at least one remote electronic device including a second antenna tuned to exchange signals with the first antenna, wherein the remote electronic device includes a thermal protection block in which the second antenna is embedded, and the second antenna is tuned in such a way that the second antenna and the thermal protection block form a radiating assembly having a second bandwidth coinciding with the first bandwidth.

2. The system according to claim 1, wherein the remote electronic device comprises at least one electronic component for tuning the second antenna, the tuning electronic component having been chosen to compensate for a shift in resonance frequency of the second antenna caused by the thermal protection block.

3. The system according to claim 1, wherein the thermal protection block has, around the second antenna, a thickness determined according to a thermal conductivity of the thermal protection block and an estimated surrounding temperature during operation, and the tuning of the second antenna depends on said thickness.

4. The system according to claim 1, wherein the thermal protection block is made of a polymer resin.

5. The system according to claim 4, wherein the polymer resin has a thermal conductivity of less than 1 W/(m·K).

6. The system according to claim wherein the polymer resin is a silicone resin or an epoxy resin.

7. A vehicle including at least one propulsion engine disposed in an engine compartment, and the system according to any claim 1, wherein the remote device is fastened in the engine compartment.

8. The vehicle according to claim 7, wherein the vehicle is n aircraft.

9. The vehicle according to claim 8, wherein the aircraft is a helicopter.
